(19) United States
(12) Patent Application Publication
(10) Pub. No.: US 2014/0143037 A1
(43) Pub. Date: May 22, 2014

(54) SYSTEMS AND METHODS TO OWN A FREE COMPUTER, A FREE MOBILE DEVICE AND A FREE WEARABLE DEVICE AND LIFE TIME WARRANTY VIA THE SAME DEVICE PAYMENT CASHBACK

(71) Applicants: Tiger T G Zhou, Tiburon, CA (US); Dylan T X Zhou, San Gabriel, CA (US); Andrew H B Zhou, Tiburon, CA (US)

(72) Inventors: Tiger T G Zhou, Tiburon, CA (US); Dylan T X Zhou, San Gabriel, CA (US); Andrew H B Zhou, Tiburon, CA (US)

(21) Appl. No.: 14/165,826

(22) Filed: Jan. 28, 2014

Related U.S. Application Data
(63) Continuation-in-part of application No. 13/646,706, filed on Oct. 7, 2012.
Application No. 13/646,706 is a continuation-in-part of application No. 13/661,207, filed on Oct. 26, 2012.
Application No. 13/661,207 is a continuation-in-part of application No. 13/760,214, filed on Feb. 6, 2013.
Application No. 13/760,214 is a continuation-in-part of application No. 13/185,491, filed on Jul. 18, 2011.
Application No. 13/185,491 is a continuation-in-part of application No. 13/973,146, filed on Aug. 22, 2013.
Application No. 13/973,146 is a continuation-in-part of application No. 13/287,279, filed on Nov. 2, 2011.
Application No. 13/287,279 is a continuation-in-part of application No. 13/875,311, filed on May 2, 2013.
Application No. 13/875,311 is a continuation-in-part of application No. 13/620,775, filed on Sep. 15, 2012.

(51) Int. Cl. G06Q 30/02

(52) U.S. Cl. CPC G06Q 30/0226; G06Q 30/0215
USPC 705/14.17

(57) ABSTRACT

Provided are computer implemented methods and systems for providing compensation for using a mobile payment service. An exemplary system comprises a processor and a database in communication with the processor. The processor is configured to receive a deposit amount associated with a purchase related to a user. The purchase is made via the mobile payment service. The processor is further configured to receive payment information associated with the user. The payment information is associated with a mobile payment account of the user in the mobile payment service. When the processor receives a notification about a further purchase of the user via the mobile payment service, compensation from the deposit amount is provided. The compensation is proportional to a payment amount associated with the further purchase. The database is configured to store at least the deposit amount and the payment information.

### CROSS-REFERENCE TO RELATED APPLICATIONS

This application is a continuation-in-part of U.S. patent application Ser. No. 13/875,311, entitled “FACILITATING MOBILE DEVICE PAYMENTS USING MOBILE PAYMENT ACCOUNT, MOBILE BARCODE AND UNIVERSAL DIGITAL MOBILE CURRENCY,” filed on May 2, 2013, U.S. patent application Ser. No. 13/620,775, entitled “METHODS AND SYSTEMS FOR FACILITATING MOBILE DEVICE PAYMENTS USING CODES AND CASHBACK BUSINESS MODEL,” filed on Sep. 15, 2012, U.S. patent application Ser. No. 13/661,207, entitled “METHODS AND SYSTEMS FOR RECEIVING COMPENSATION FOR USING MOBILE PAYMENT SERVICES,” filed on Oct. 26, 2012, U.S. patent application Ser. No. 13/760,214, entitled “WEARABLE PERSONAL DIGITAL DEVICE FOR FACILITATING MOBILE DEVICE PAYMENTS AND PERSONAL USE,” filed on Feb. 6, 2013, U.S. patent application Ser. No. 13/973,146, entitled “WEARABLE AUGMENTED REALITY EYEGLASS COMMUNICATION DEVICE INCLUDING MOBILE PHONE AND MOBILE COMPUTING VIA VIRTUAL TOUCH SCREEN GESTURE CONTROL AND NEURON COMMAND,” filed on Aug. 22, 2013, U.S. patent application Ser. No. 13/646,706, entitled “METHODS AND SYSTEMS FOR PREVENTING CARD PAYMENT FRAUD AND RECEIVING PAYMENTS USING CODES AND MOBILE DEVICES,” filed on Jul. 18, 2011, U.S. patent application Ser. No. 13/287,279, entitled “METHODS AND SYSTEMS TO ADVERTISE AND SELL PRODUCTS OR SERVICES VIA CLOUD GAMING ENVIRONMENTS,” filed on Nov. 2, 2011, and U.S. patent application Ser. No. 13/185,491, entitled “FACILITATING MOBILE DEVICE PAYMENTS USING PRODUCT CODE SCANNING,” filed on Jul. 18, 2011, and which are incorporated herein by reference in its entirety.

### FIELD

This application relates generally to data processing, and more specifically to methods and systems for providing compensation for using mobile payment services.

### BACKGROUND

When customers buy product items from various merchants in these merchants' retails environments, such as retail outlets, shopping centers, stores, etc., only a handful of payment methods is available to the customers. Typical examples include credit cards, debit cards, gift cards, checks, and cash. Each one of these payment methods has some drawbacks from cost and/or convenience perspectives. For example, credit cards bear substantial processing fees, while debit cards require availability of funds and sometimes involve surcharges as well. Checks and cash transactions are slow and require additional processing and/or handling. All these drawbacks interfere with retail transactions and add some level of dissatisfaction.

Additionally, many stores and retailers provide bonuses and discounts for regular customers to stimulate customers to return over and over.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are computer implemented methods and systems for providing compensation for using a mobile payment service. Using the methods or systems described herein an individual or organization may receive a device, detail part or service for free on condition of using a mobile payment service. For this purpose, the individual or organization purchases a device, detail part or service via the mobile payment service. The purchase price of the device, detail part or service is transferred to the system for providing compensation for using mobile payment service as a deposit amount. Additionally, payment information of the user is received by the system for providing compensation for using mobile payment service. The payment information is associated with a mobile payment account of the user in the mobile payment service and can include bank account information, credit card information, debit card information, gift card information, prepaid card information, insurance account information, merchant account information, mobile currency information, digital money account, SDK payment information, in-app payment information, social networking payment information, prepaid card information, API payment information, mobile account payment information, mobile currency information, and so forth.

When the user makes a further purchase via the mobile payment service, the system for providing compensation for using mobile payment service receives a notification, which includes at least the payment amount of the further purchase and identification information of the user to associate the user with the mobile payment account.

The system for providing compensation for using mobile payment service calculates a compensation associated with the further purchase using predefined criteria. For example, the compensation can be calculated as a certain percent of the payment amount of the further purchase. The calculated compensation is deducted from the deposit amount and provided to the user. The compensation can be provided by transferring it to an account associate with the mobile payment account of the user or otherwise as specified by the user. The compensation is provided for the purchases of the user until the deposit amount exhausts.

In various embodiments, the compensation can include free repair of the mobile device, free exchange of the mobile device, free receipt of spare parts for the mobile device, free of dongles charges by scanning payment cards information, free of monthly phone fee, and so forth. Additionally, the compensation can include loyalty credits provided for participation in loyalty programs, a repayment of a percentage of an amount of purchases made with the mobile payment service provider, a refund of bank services, a discount on mobile services, free mobile services, zero monthly fee, free bank services, free insurance services, saved payment card charges. The free bank service include early account closure fee, monthly or annual maintenance fee, minimum balance fee, refundable deposit fee, foreign transaction fee, lost debit card fee, bank statement fee, redeemed rewards points fee, retained mail fee, refundable mail fee, help desk fee, wire transfer fee, stop payment fee. The free bank services can be provided by a related bank or a bank of the mobile payment service provider.

The free insurance services can include life insurance, health insurance, property insurance, liability insurance, and casualty insurance. The free insurance services can be provided by an insurance company of the mobile payment service provider or related insurance company.

In some embodiments, the user can add up further deposit amount if the original device needs repair or servicing. All costs of detail parts or repairs for the original device associated with the purchase can be added to the deposit amount and then compensated as described above.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF DRAWINGS

Embodiments are illustrated by way of example and not limitation in the figures of the accompanying drawings, in which like references indicate similar elements and in which:

FIG. 1 is a block diagram showing an environment within which a method and system for providing compensation for using a mobile payment service can be implemented, in accordance with an example embodiment.

FIG. 2 is a block diagram showing various modules of the system for providing compensation for using a mobile payment service, in accordance with certain embodiments.

FIG. 3 is a flow chart illustrating a method for providing compensation for using a mobile payment service, in accordance with certain embodiments.

FIG. 4 is a block diagram illustrating a purchase via a mobile payment service associated with a system for providing compensation for using a mobile payment service, in accordance with certain embodiments.

FIG. 5 is a block diagram illustrating a compensation for purchases via a mobile payment service, in accordance with certain embodiments.

FIG. 6 shows a diagrammatic representation of a computing device for a machine in the exemplary electronic form of a computer system, within which a set of instructions for causing the machine to perform any one or more of the methodologies discussed herein, can be executed.

### DETAILED DESCRIPTION

Various computer implemented methods and systems for providing compensation for using a mobile payment service are described herein. Expansion of computer networks (Internet) gave rise to a new type of trade—electronic trade, while proliferation of mobile devices (e.g., cell phones/smart phones and other similar devices) that are capable of internet communications take electronic trade even further. A customer can shop online from any location using a mobile device. Therefore, mobile payment services gain increasing importance.

While physical retailers provide discounts or other bonuses for regular customers, a mobile payment service can motivate customers to perform online purchases though their service repeatedly in a different way. The mobile payment service may provide compensation for using the service. The compensation can be proportional to the purchase amount. Additionally, the compensation can be associated with a particular purchase or service to the user of the mobile payment service. For example, the user buys a device via the mobile payment service and receives compensation for further purchases via the mobile payment service until exhaustion of the price of the device. In such a way, the user gets a free device for using the mobile payment service.

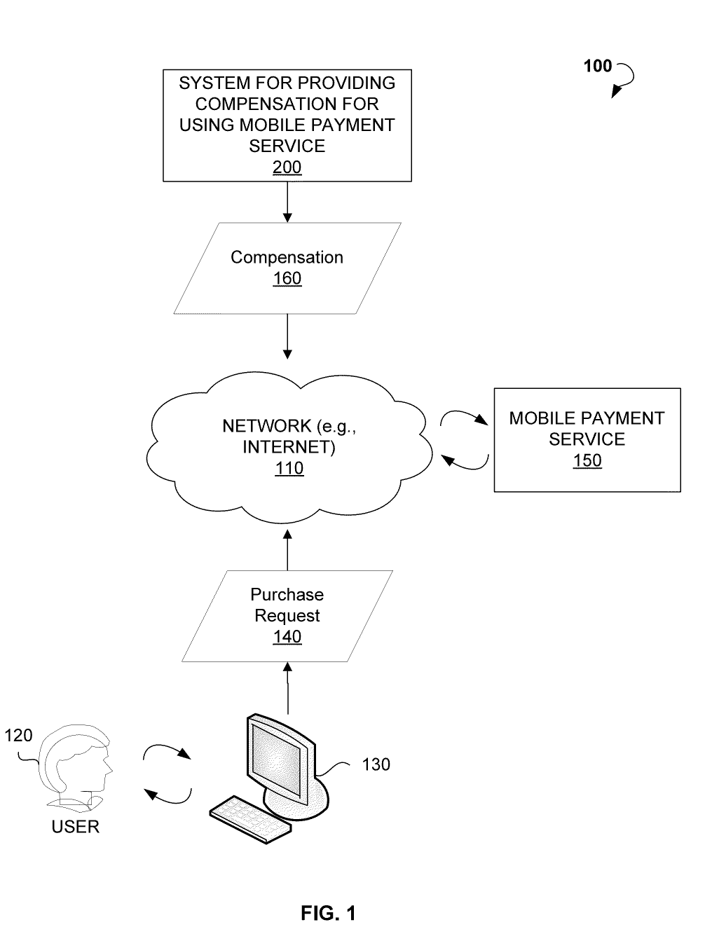

Referring now to the drawings, FIG. 1 illustrates an environment 100 within which systems and methods for providing compensation for using a mobile payment service can be implemented. The environment 100 may include a user 120, a client device 130, network 110, a mobile payment service 150, and a system 200 for providing compensation for using a mobile payment service. The compensation can be exchanged for a free item, such as a free computer, a free mobile device, a free wearable device, a free internet-connected device, a free home device, a free table tablet computer, a free chair tablet computer, a free internet of things device, a free monthly charge, a free life time warranty, a free Bluetooth-connected device, a free beacon-connected device, a free Point of Sale device, and a free mobile payment stand device, and so forth.

The user 120 may include an individual, organization, or entity associated with a crowdsourcing item. The user may purchase a device, a detail part, or receive a service from the mobile payment service 150. A price of the device, detail part, or service is deposited to the system 200. The deposit amount equals the price of the device, detail part, or service. When the user 120 makes further purchases via the mobile payment service 150, he receives compensation from the deposit amount. The amount of the compensation is proportional to the purchase amount.

The user 120 communicates with the mobile payment service 150 and the system 200 via the network 110 using the client device 130.

The network 110 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a Universal Serial Bus (USB) connection or other wired or wireless, digital or analog interface or connection, mesh or Digi® networking. The network 110 may include any suitable number and type of devices (e.g., routers and switches) for forwarding commands, content, and/or web object requests from each client to the online community application and responses back to the clients.

The client device 130, in some example embodiments, may include a Graphical User Interface (GUI) for displaying the user interface associated with the system 200 and the mobile payment service 150. In a typical GUI, instead of offering only text menus or requiring typed commands, the system 200 may present graphical icons, visual indicators, or special graphical elements called widgets that may be utilized to allow the user 120 to interact with the system 200 and/or the mobile payment service 150. The client device 130 may be configured to utilize icons used in conjunction with text, labels, or text navigation to fully represent the information and actions available to user 120.

The client device 130 may include a mobile telephone, a computer, a lap top, a smart phone, a tablet PC, a wearable device, an eyeglass device, and so forth. When the user 120 makes one of further purchase, a purchase request is sent to the mobile payment service 150. The payment request 140 sent by the user 120 via the client device 130 may be stored and executed by the mobile payment service 150. Additionally, the system 200 can be informed about the purchase request 140 and its execution. The system 200 then calculates a compensation amount and provides the compensation 160 to the user. The compensation can be provided by a bank, a credit card company, an insurance company, a credit union, a mobile payment service provider, and/or a store.

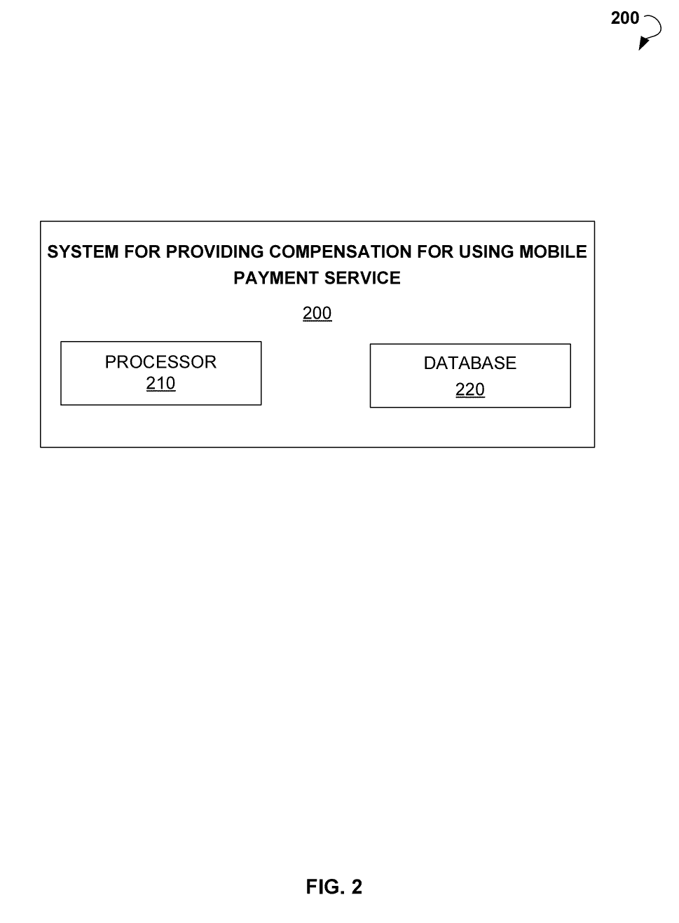

FIG. 2 is a block diagram showing various modules of the system 200 for providing compensation for using mobile payment service, in accordance with certain embodiments. The system 200 may comprise a processor 210 and a database 220. The processor 210 may include a programmable processor, such as a microcontroller, central processing unit (CPU), and so forth. In other embodiments, the processor 210 may include an application-specific integrated circuit (ASIC) or programmable logic array (PLA), such as a field programmable gate array (FPGA), designed to implement the functions performed by the system 200. Thus, the processor 210 may receive a registration request to register the user in the mobile payment service. The user can send the registration request via a mobile payment card application installed on the mobile device related to the user. The registration request includes one or more of the following: a name of the user, an address of the user, a guarantor name, a social security number of the user, a phone number of the user, an identification number of the user, a bank account of the user, an insurance account number of the user, and a photograph of the user. The mobile payment card application can provide mobile payment services as well as free Voice over IP (VoIP) service, a free Over-the-Top (OTT) service, and so forth.

In some embodiments, a bank may deploy mobile payment card applications or devices to customers and ensure merchants have the required point of sale (POS) acceptance capability.

Based on the registration request, the processor registers the user mobile payment service.

Then, a deposit amount associated with a purchase of the user is received by the processor 210. The purchase is performed via the mobile payment service and is associated with a mobile payment account of the user in the mobile payment service. Thus, the processor also receives payment information associated with the mobile payment account of the user the mobile payment service. The mobile payment account can include a personal account, a commercial account, a non-profit account, and so forth.

When the user makes a further purchase via the mobile payment service, a notification about a further payment request is received by the processor and compensation proportional to further purchase amount is provided to the user. In some embodiments, the compensation is transferred to the account associated with the mobile payment account of the user.

The information associated with the deposit amount and the payment information may be stored in the database 220 and may be accessible for user.

In some embodiments, the system 200 can also include a user interface (not shown) configured to visualize data associated with the mobile payment service.

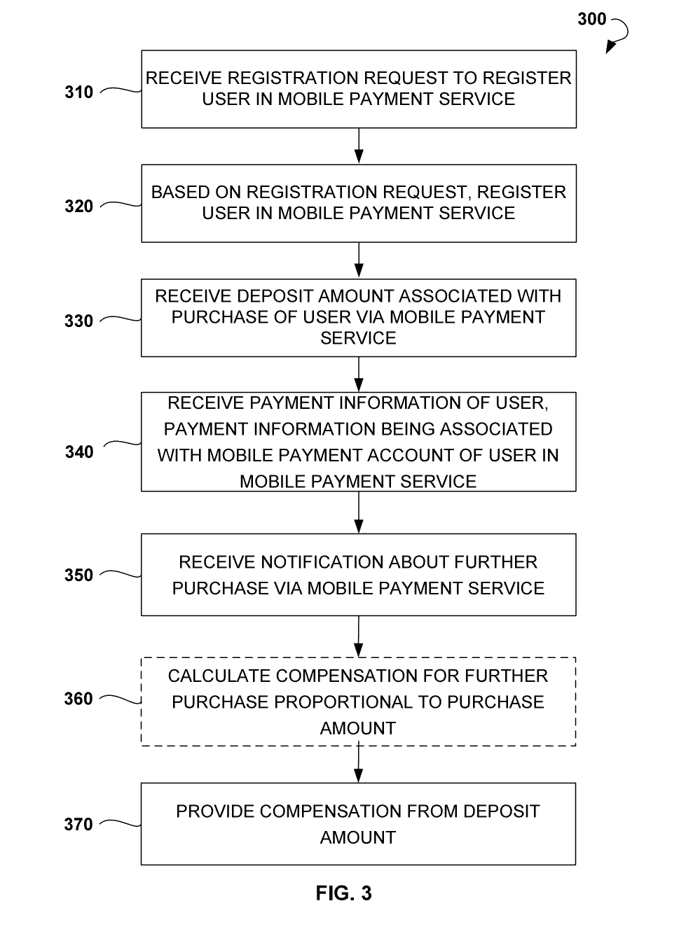

FIG. 3 is a flow chart illustrating a method 300 for providing compensation for using a mobile payment service, in accordance with some example embodiments. The method 300 may be performed by logic that may comprise hardware (e.g., dedicated logic, programmable logic, and microcode), software (such as software run on a general-purpose computer system or a dedicated machine), or a combination of both. In one example embodiment, the processing logic resides at the system 200 for providing compensation for using a mobile payment service, and the various elements of the system 200 can perform the method 300. It will be appreciated by one of ordinary skill that examples of the foregoing modules may be virtual, and instructions said to be executed by a module may, in fact, be retrieved and executed by software. Although various elements may be configured to perform some or all of the various operations described herein, fewer or more elements may be provided and still fall within the scope of various embodiments.

As shown in FIG. 3, the method 300 may commence at operation 310 with receiving a registration request to register the user in the mobile payment service. The user can send the registration request via a mobile payment card application installed on the mobile device related to the user. The mobile device can include one or more of the following: a mobile phone, a personal digital assistant, a lap-top, a tablet personal computer, a smart phone, a digital watch, augmented reality glasses, a digital bracelet, a digital ring, a wearable personal digital device, a desktop computer, and an internet-connected TV-set. The mobile payment card application can provide mobile payment card services as well as free Voice over IP (VoIP) service, a free Over-the-Top (OTT) service, and so forth. The free VoIP service and the free OTT service include voice communication, fax, text messaging, voice messaging, video communication, and multimedia transmission. In various embodiments, the free VoIP service and the free OTT service are provided via Wi-Fi, 3G network, 4G network, 5G network, 6G network or upper.

Based on the registration request, the user is registered in the mobile payment service at operation 320.

Additionally, a creditworthiness rating of the user can be calculated by checking credit history of the user. The creditworthiness rating can include verification of employment status of the user.

At operation 330, a deposit amount associated with a purchase of the user is received via the mobile payment service. The purchase includes a device, a detail part, a service provided to the user, and so forth. The deposit amount equals the price of the purchase. At operation 340, the processor receives payment information associated with the user, the payment information being associated with a mobile payment account of the user in the mobile payment service. The payment information includes bank account information, credit card information, debit card information, gift card information, a retail card, a charge card, a stored-value card, digital money, a prepaid card, a gift card, a merchant card, a mobile account card, a mobile currency card, and so forth. The payment information may be used to provide compensation to the user for further purchases and for other purposes. The compensation can be issued by a bank, a credit card company, an insurance company, a credit union, and/or a store.

Prepaid mobile payment card, also called re-loadable mobile payment card, may be safer than carrying cash, and for a small payment such as a cup of coffee avoiding per transaction fees by a third party issuer. Prepaid mobile payment card may be good for unbanked people and poor credit rating people.

The user can make a payment via the mobile payment service through an application on the mobile device. The payment can include an online payment. Online payments can be secured by two-factor authorization.

When the user makes a further purchase via the mobile payment service, a notification about the further purchase is received by the processor 210 at operation 350. The notification can include a payment amount of the further purchase and credentials associated with the mobile payment account of the user. Thus, the user can be authenticated and associated with the deposit amount.

The mobile payment card can encode one or more of the following: a picture of a face of the user, one or more fingerprints of the user, and a pin code. User data and mobile payment cards can be protected via an on-demand contact list backup and retrieval to and from the cloud. Additionally, the user can specify a time period during which the mobile payment card is valid.

At optional operation 360, a compensation associated with the further purchase is calculated. The compensation can be proportional to the payment amount of the further purchase. For example, the compensation can equal 3% of the payment amount of the further purchase. Alternatively, the calculation is performed according to predefined criteria.

At operation 370, the compensation is provided from the deposit amount. The compensation can be transferred to the account associated with the mobile payment of the user. The compensation can be transmitted to the mobile device of the user via a wireless network. In some embodiments, the user is allowed to use the compensation for payments in the mobile payment service only.

The provided compensation is deducted from the deposit amount until the deposit amount exhausts. In the result, the user can receive the full price of the purchase for his further purchases in the mobile payment service. Thus, the user can receive the purchase for free.

Additionally, the method can include receiving content over broadband communication.

In some embodiments, the method can comprise an optional operation of issuing a mobile payment card associated with the user. The mobile payment card can be issued via the mobile payment card application. The issuing depends on approving of the mobile payment account by a mobile payment service provider. The mobile payment card can be a virtual card and its information can be encoded in a barcode which prevents fraud and is more secure than physical plastic payment cards. Additionally, the mobile payment card can be associated with a bank card. The user can specify whether a payment is charged to the bank card account or another account. The user can apply the mobile payment card for internet payments using the mobile device or further devices. Online payments using the mobile payment card are secured by two-factor authorization.

Mobile payment cards are issued by mobile payment card issuer after an account has been approved by the mobile payment provider. After which card holders can use it to make purchases at merchants accepting that card. When a purchase is made, the mobile payment card user agrees to pay the mobile payment issuer, the mobile payment card holder indicates consent to pay by signing a receipt or press agree button on user's mobile device screen and indicating the amount to be paid or by entering a pin. Merchants may accept verbal authorizations via telephone and electric authorization using the internet as a mobile payment card not present transaction. Electronic verification systems allow merchants to verify in a few seconds that the mobile payment card is valid or not ant the mobile payment card user has sufficient credit or enough bank account amount to cover the purchase. The verification is performed using mobile payment terminal or point-of-sale (POS) system, or scanner, or another mobile device with a communication link to the merchants acquiring bank or user's bank. Data from the mobile payment card is obtained by scanning or decoding. For mobile payment not present transactions where the mobile payment card is not shown for example such as e-commerce, mail order and telephone sales. Merchants may additionally verify that the user is in physical possession of the mobile payment card and is the authorized user by asking for additional information such as the security code, date of expiration, and billing address.

Each month, the mobile payment card user is sent a statement indicating the purchases undertaken with the mobile payment card, any outstanding fees, and the total amount owned of mobile credit card.

Merchants, banks, and mobile payment card providers may offer the option of electronic statements, either in lien of or in addition to physical statements, which can be viewed at anytime by the mobile payment card holder via the user's mobile device screens and via the issuer's online websites. Notification of the availability of a new statement is generally sent to the mobile payment card holder's email address. Mobile payment card holder may have other options besides a physical check, such as an electronic transfer from a mobile payment account or a checking account. May have peer to peer, mobile device to mobile device direct transactions, depending on the issuer, the mobile payment card holder may also be able to make multiple payments at any time and any place.

Mobile payment card may have online and offline systems. Online mobile payment cards require electronic authorization of every transaction and credits and debits are reflected in the user's account immediately. The transaction may be additionally secured with personal identification number (pin) authentication system. Offline mobile payment cards may be in barcode for m on a material surface encoding all mobile payment cards information which can be decoded by scanner and any mobile device with a decoding software to make a payment.

Mobile payment card may be an electronic purse system in which value is stored on the mobile payment card virtual chip, not in an externally recorded account, so that machines accepting the card need no network connectivity.

In some embodiments, a payment via the mobile payment card can be performed as a direct operator billing.

Additionally, mobile payments may have a collaboration model. This model may involve collaboration among banks, mobile operators and a trusted third party.

The mobile payment card can be associated with transactional payments based on Unstructured Supplementary Service Data (USSD) or Short Message Service (SMS), direct operator billing, credit card mobile payments, online wallets, QR code payments, contactless near field communication, cloud-based mobile payments, audio signal-based payment, Bluetooth Low Energy (BLE) signal beacon payment, in-application payment, SDK payment, API payment, social networking payment, and direct carrier/bank co-operation.

Direct mobile billing option can be applied during checkout at a e-commerce site. After two-factor authentication involving a pin and one time password, the user's mobile account is charged for the purchase, thus bypassing banks and plastic payment card companies altogether. Direct operator billing or carrier billing can require integration with the mobile operator to add to customer's bill to provide instantaneous payment. Direct operator billing may be deployed in an in-app environment.

In some embodiments, the user makes payments via web pages displayed or additional applications downloaded and installed on the mobile device. For this purpose, a wireless application protocol (WAP) can be used as underlying technology and the mobile web payment can lead back to a store or to other goods the user may like.

As an easy way to inject information into a mobile device, barcodes can be used. The user just clicks to open the application, directly showing the encoded payment card on the screen. Merchant just scans the barcode information and gets paid.

Contactless near field communication (NFC) may be used in paying for purchases in physical stores or transportation services. The mobile device may be equipped with a smart card. When a user waves the device near a radar module a payment is made. In some cases, the payment may require authentication. The NFC payment could be deducted from a pre-paid account or changed to a mobile or band account directly. NFC payment may include displaying a barcode on the mobile device screen for mobile payment. The payment barcode can include one or more of the following: a linear barcode, a two-dimensional barcode, a three-dimensional barcode, a machine readable code, and so forth.

The audio channel of the mobile phone may be another wireless interface that is used to make payments. Chip, ultra sound and acoustic features of mobile phone may support mobile payments. Near sound data transfer (NDST), data over voice and NFC produce audio signatures that the mobile phone can pick up to enable electronic transactions.

In some embodiments, a beacon mobile payment sends out a Bluetooth Low Energy (BLE) signal to anyone or any device with mobile application to transfer payment data and get electrical receipt. When a customer checks in, their picture and name may pop up on the retailer's point-of-sale system, when a sales associate at the store totals a bill on a cash register or a card-reading terminal, the beacon mobile payment user gives verbal confirmation to the associate, who matches the customer with the picture on the POS screen and concludes the transaction.

The mobile payment card can be used as a prepaid card. Additionally, the mobile payment card can be associated with a revolving account and a credit line granted to the user for making payments.

In some embodiments, the mobile payment card is associated with one or more of the following: a daily limit for a maximum amount of expenditures, a limit for a minimum balance. In some cases, the mobile payment card provides cash-back according to predetermined conditions.

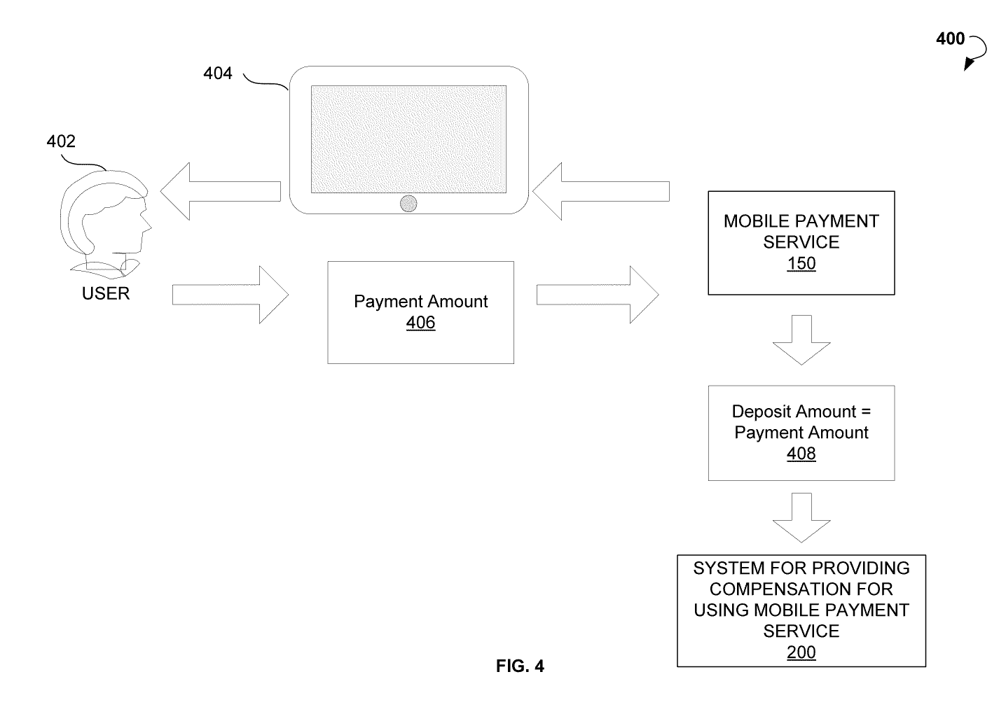

FIG. 4 is a block diagram illustrating a purchase 400 via a mobile payment service associated with a system for providing compensation for using a mobile payment service, in accordance with certain embodiments. A user 402 purchases a device 404 via the mobile payment service 150. Though in this case the device 404 is used to illustrate a purchase, other variants are possible, such as purchasing a detail part or a service.

The user 402 transfers a payment amount 406 for the device 404. The payment amount is stored as a deposit amount 408 in the system 200 for providing compensation for using mobile payment service.

In some embodiments, a merchant associated with the purchase is charged with a predefined fee deducted from the payment amount.

Contactless near field communication (NFC) may be used in paying for purchases in physical stores or transportation services. The mobile device may be equipped with a smart card. When a user waves the device near a radar module a payment is made. In some cases, the payment may require authentication. The NFC payment could be deducted from a pre-paid account or changed to a mobile or band account directly. NFC payment may include displaying a barcode on the mobile device screen for mobile payment.

The audio channel of the mobile phone may be another wireless interface that is used to make payments. Chip, ultra sound and acoustic features of mobile phone may support mobile payments. Near sound data transfer (NDST), data over voice and NFC produce audio signatures that the mobile phone can pick up to enable electronic transactions.

In some embodiments, a beacon mobile payment sends out a Bluetooth Low Energy (BLE) signal to anyone or any device with mobile application to transfer payment data and get electrical receipt. When a customer checks in, their picture and name may pop up on the retailer's point-of-sale system, when a sales associate at the store totals a bill on a cash register or a card-reading terminal, the beacon mobile payment user gives verbal confirmation to the associate, who matches the customer with the picture on the POS screen and concludes the transaction.

In some embodiments, merchants may be charged a predefined fee for accepting mobile payment cards. The fee of, for example, 0.3 to 5 percent of the value of each transaction may be charged by mobile payment card issuer. The merchant may also pay a variable interchange rate fees for each transaction in certain cases, merchants are also required to lease processing terminals such as scanner, mobile devices. Merchants can also be required to satisfy data security compliance, and in some cases, merchants may assume the risk of charge backs by consumers. The issuer charges may be lower than plastic payment cards when mobile payment card users directly pay to merchant rather than through third party such as bank.

The mobile payment card can be used with a customized version of the open standard Extensible Messaging and Presence Protocol. Upon installation of the mobile payment card application, a user account is created using the phone number or name of the user as user name. The mobile payment cards application and user name automatically compares all the phone numbers from the device address book with its central database of users to automatically add contacts and send mobile payment cards barcode to the user's contact list to charge the payments.

Additionally, the mobile payment card application can include a cross-platform instant messaging subscription service. The cross-platform instant messaging subscription service can be a free mobile messages application for mobile devices, such as smartphones, with free text and free call features, hold-to-talk messaging, broadcast messaging, photo and video sharing, location sharing, contact information exchange, and social networking payment support. For any of the features, the user can specify a validity period. Via the service, the user can send one or more mobile payment card barcodes, images, video, and audio media messages to further users. The cross-platform instant messaging subscription service can be compatible with Google Android, iPhone IOS, Microsoft Windows Phone and other operation systems.

Furthermore, the mobile payment card application can provide tools to capture one or more images, embellish the one or more images with artistic filters and captions, and place the one or more images into a personal photo journal for sharing with further users.

The mobile payment service can have an operator-centric model, bank-centric model, collaboration model or peer-to-peer independent model. The user can apply the mobile payment service using a further device. The mobile payment service can be associated with a revolving account and a credit line granted to the user for making payments. In some embodiments, the mobile payment service is used for internet payments.

For internet payments, the mobile payment service may have mobile option—online wallets to let user register, input their phone number, and the mobile payment service sends them an SMS with a pin, and user enters the received pin, authenticating the number, then user inputs their plastic card info to validate payment.

Mobile payment cards, mobile wallet and mobile payments can be provided a software developers kit (SDK) and application programming interface (API) that enable successors, banks, processors, and third parties to embed cloud resident mobile payment cards, mobile wallet, mobile payments and contactless payment functionality into their own mobile apps. Keeping their customers in their app and thinking about their brand—all the way through checkout. APIs and SDKs of mobile payment cards, mobile wallet, and mobile payments may integrate with existing POS systems, web portals, single sign-on capabilities, advertising networks and the mobile phone app itself. Mobile payment cards, mobile wallet and mobile payments may provide software—only platform that leverages mobile phone audio channels and cameras to bring intuitive and secure mobile payments functionality to existing mobile devices and point-of-sale hardware. The system supports in-store, ecommerce, dining, bill pay, P2P.

Mobile payment cards may be more secure than other forms of payment, such as checks, because the issuer commits to pay the merchant the moment the transaction is authorized. In most cases, mobile payment cards may be even more secure than cash, because they discourage theft by the merchant's employees and reduce the amount of cash on the premises.

Mobile payment cards may also be used on internet either with or without using a pin. Internet transactions may be conducted in either online or offline mode. Internet purchases can be authenticated by the user entering their pin if the merchant has enabled a secure online pin pad. Mobile payment card issuer may waive interest charges if the balance is paid in full each month, but typically will charge full interest on the entire outstanding balance from the date of each purchase if the total balance is not paid. Mobile payment cards may become a complicated financial instrument with multiple balance segments each at a different interest rate.

Mobile payment cards main benefit to user is convenience compared to cash or check. It may allow a small short-term loss to be quickly made to a user who needs not calculate abundance remaining before every transaction. Mobile payment cards may offer rewards and benefit packages, such as enhanced product warranties at no cost, free loss/damage coverage on new purchases, various insurance protection, for example, rental car insurance protection, common carrier accident protection, and travel medical insurance. Mobile payment cards can also offer reward points which may be redeemed for cash, products, or airline tickets. Mobile payment cards can also offer cash-back on certain conditions.

A simple mobile web payment system may also include a plastic card payment (such as a credit card) flow allowing user to enter their card details to make purchases or turning plastic card payments into simple single click-to-buy giving higher conversion rates for additional purchases.

In some embodiments, the user makes a payment using a web page displayed or an additional application downloaded and installed on the mobile device. The user may use WAP (wireless application protocol) as underlying technology, the mobile web payment can lead back to a store or to other goods the user may like.

In some embodiments, barcode payments (such as QR code) may be an easy way to inject info into mobile phone, and user just one click to open the application, directly showing the encoded payment card on the screen together with a with a slide 1-100% tips selection to choose to pay with the merchant. Merchant just scans the barcode information and gets paid.

Cloud-based payments may approach to in-store mobile payment. First, a cloud linked payment method is selected, the payment provider automatically covers the cost of the purchase with the issuer linked funds. Secondly, in a separate transaction, the payment provider charges the purchaser's selected, cloud-linked account in a card-not-present environment to recoup its losses on the first transaction.

In some embodiments, the mobile phone carrier may be a front end interface to users. User may purchase goods, transfer money to a peer, cash out, and cash in. A mini wallet account can be opened as simple as entering a certain number on the mobile phone, presumably by depositing money at a participating local merchant and the mobile phone number. Other transactions can be similarly accomplished by entering special codes and the phone number of the other party on the consumer's mobile phone.

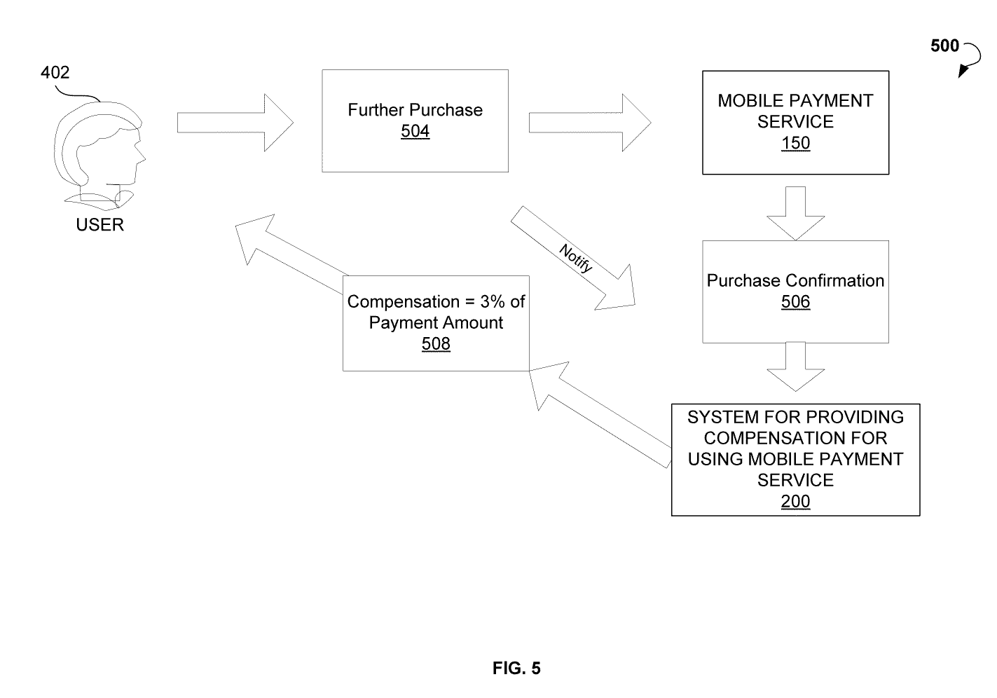

FIG. 5 is a block diagram illustrating a compensation 500 for a further purchase via a mobile payment service, in accordance with certain embodiments. When the user 402 makes a further purchase 504 via the mobile payment service 150, the system 200 is notified. The notification includes at least the payment amount of the further purchase and credentials of the user to associate the user with the mobile payment account. In some embodiments, the mobile payment service 150 sends a confirmation of the further purchase 506 to the system 200 to verify that the further purchase is successful.

Based on the notification, the system 200 calculates the compensation for the further purchase 508 and transfers the compensation to the account associated with the user 402. The compensation is calculated based on predetermined criteria. For example, the compensation can equal 3 percent of the payment amount of the further purchase.

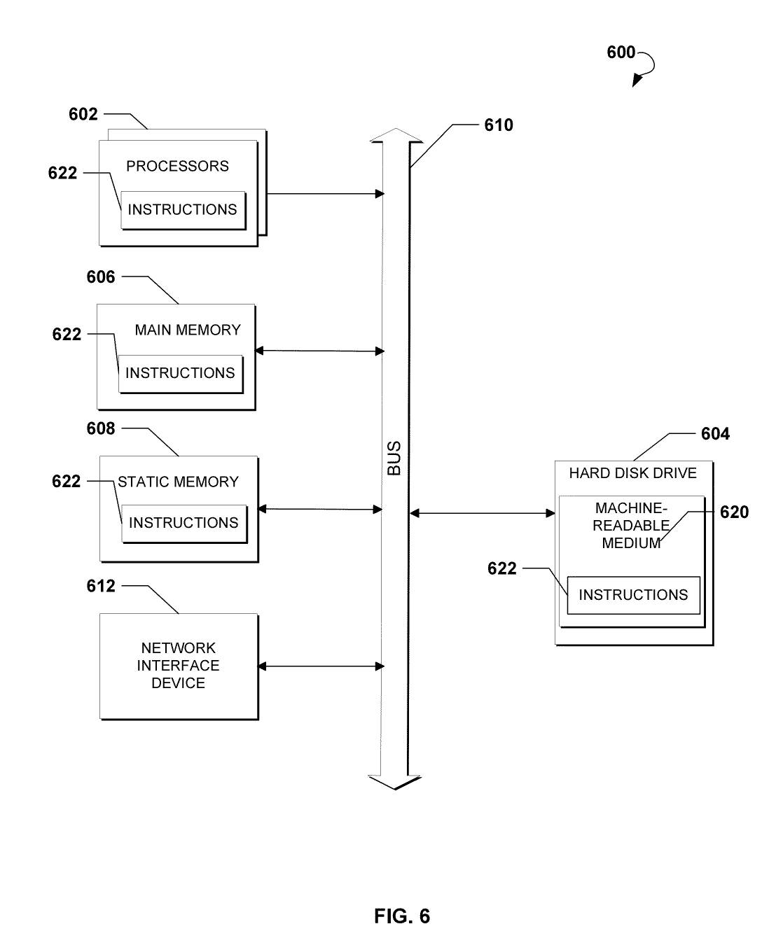

FIG. 6 shows a diagrammatic representation of a computing device for a machine in the exemplary electronic form of a computer system 600, within which a set of instructions for causing the machine to perform any one or more of the methodologies discussed herein can be executed. In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a cellular telephone, a digital camera, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor or multiple processors 602, a hard disk drive 604, a main memory 606 and a static memory 608, which communicate with each other via a bus 610. The computer system 600 may also include a network interface device 612. The hard disk drive 604 may include a computer-readable medium 620, which stores one or more sets of instructions 622 embodying or utilized by any one or more of the methodologies or functions described herein. The instructions 622 can also reside, completely or at least partially, within the main memory 606 and/or within the processors 602 during execution thereof by the computer system 600. The main memory 606 and the processors 602 also constitute machine-readable media.

While the computer-readable medium 620 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, RAM, ROM, and the like.

The exemplary embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, C, C++, C# or other compilers, assemblers, interpreters or other computer languages or platforms.

Thus, various systems and methods for providing compensation for using a mobile payment service have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A method for providing compensation for using a mobile payment service, the method comprising:
receiving, by a processor from a user, a registration request to register the user in the mobile payment service, wherein user sends the registration request via a mobile payment card application associated with a mobile device related to the user, the mobile payment card application providing at least a free Voice over IP (VoIP) service and a free Over-the-Top (OTT) service;
based on the registration request, registering the user mobile payment service;
receiving, by the processor, a deposit amount associated with a purchase of the user, the purchase made via the mobile payment service, wherein the user makes the purchase using the mobile payment card application;
receiving, by the processor, payment information associated with the user, the payment information being associated with a mobile payment account of the user in the mobile payment service, wherein the mobile payment account includes a personal account, a commercial account, and a non-profit account;
receiving, by the processor, a notification about a further purchase of the user via the mobile payment service;
providing a compensation from the deposit amount, the compensation being proportional to a payment amount associated with the further purchase;
wherein the compensation is exchanged for a free item, wherein the free item includes a free computer, a free mobile device, a free wearable device, a free internet-connected device, a free monthly charge, a free home device, a free table tablet computer, a free chair tablet computer, a free internet of things device, a free life time warranty, a free Bluetooth-connected device, a free beacon-connected device, a free Point of Sale device, and a free mobile payment stand device.

2. The method of claim 1, wherein the compensation amounts to a predetermined percent from the payment amount.

3. The method of claim 1, further comprising: calculating the compensation based on the further purchase, wherein the calculation is performed according to predefined criteria.

4. The method of claim 1, wherein the notification includes at least the payment amount and credentials associated with the mobile payment account of the user.

5. The method of claim 1, wherein payment information includes one or more of the following: bank account information, credit card information, debit card information, gift card information, prepaid card information, insurance account information, merchant account information, mobile currency information, and digital money.

6. The method of claim 1, wherein the deposit amount equals a price of the purchase.

7. The method of claim 1, further comprising: based on the providing, deducting the compensation from the deposit amount.

8. The method of claim 1, wherein the purchase includes a device, a detail part, and a service provided to the user.

9. The method of claim 1, wherein the compensation is provided to the user until the deposit amount exhausts.

10. The method of claim 1, wherein the free VoIP service and the free OTT service include voice communication, fax, text messaging, voice messaging, video communication, and multimedia transmission.

11. The method of claim 1, wherein the free VoIP service and the free OTT service are provided via Wi-Fi, 3G network, 4G network, 5G network, 6G network or upper.

12. The method of claim 1, further comprising: issuing a mobile payment service associated with the user via the mobile payment card application.

13. The method of claim 12, wherein the user applies the mobile payment service using further devices.

14. The method of claim 12, wherein the mobile payment service is associated with a revolving account and a credit line granted to the user for making payments.

15. The method of claim 12, wherein the issuing depends on approving of the mobile payment account by a mobile payment provider.

16. The method of claim 12, wherein the mobile payment card is used as a prepaid card.

17. The method of claim 12, wherein the mobile payment service is associated with one or more of the following: a daily limit for a maximum amount of expenditures, a limit for a minimum balance.

18. The method of claim 12, wherein the mobile payment service is used for internet payments.

19. The method of claim 12, wherein the mobile payment service provides cash-back according to predetermined conditions.

20. The method of claim 12, wherein the mobile payment card is a virtual card, information of the mobile payment card being encoded in a barcode.

21. The method of claim 12, wherein the mobile payment card is associated with transactional payments based on Unstructured Supplementary Service Data (USSD) or Short Message Service (SMS), direct operator billing, credit card mobile payments, online wallets, QR code payments, contactless near field communication, cloud-based mobile payments, audio signal-based payment, Bluetooth Low Energy (BLE) signal beacon payment, in-application payment, SDK payment, API payment, social networking payment, and direct carrier/bank co-operation.

22. The method of claim 1, wherein a merchant associated with the purchase is charged with a predefined fee deducted from the payment amount.

23. The method of claim 1, wherein a mobile payment service provider has operator-centric model, bank-centric model, collaboration model or peer-to-peer independent model.

24. The method of claim 1, wherein the compensation is provided by one or more of the following: a bank, a credit card company, an insurance company, a credit union, a mobile payment service provider, and a store.

25. The method of claim 1, wherein the compensation is transmitted to the mobile device via a wireless network.

26. The method of claim 1, wherein the registration request includes one or more of the following: a name of the user, an address of the user, a guarantor name, a social security number of the user, a phone number of the user, an identification number of the user, a bank account of the user, an insurance account number of the user, and a photograph of the user.

27. The method of claim 1, further comprising: receiving content over broadband communication.

28. The method of claim 1, wherein the user applies the mobile payment service using a further device.

29. The method of claim 1, wherein the mobile payment service is associated with a revolving account and a credit line granted to the user for making payments.

30. The method of claim 1, wherein the mobile payment service is used for internet payments.

31. A system for providing compensation for using a mobile payment service, the system comprising:
a processor configured to:
receive a deposit amount associated with a purchase related to a user, the purchase made via the mobile payment service, wherein the mobile payment service is associated with a mobile payment card application associated with a mobile device related to the user;
receive payment information associated with the user, the payment information being associated with a mobile payment account of the user in the mobile payment service, wherein the mobile payment account of the user is associated with a mobile payment card;
receive a notification about a further purchase of the user via the mobile payment service; and
provide a compensation from the deposit amount, the compensation being proportional to a payment amount associated with the further purchase;
a database in communication with the processor, the database configured to store at least the deposit amount and the payment information.

32. The system of claim 31, further comprising a user interface configured to visualize data associated with the mobile payment service.

33. The system of claim 31, wherein the compensation amounts to a predetermined percent of the payment amount.

34. The system of claim 31, wherein the purchase includes a device, a detail part, and a service provided to the user.

35. The system of claim 31, wherein payment information includes one or more of the following: bank account information, credit card information, debit card information, gift card information, SDK payment information, in-app payment information, social networking payment information, prepaid card information, API payment information, mobile account payment information, mobile currency information, and digital money.

36. The system of claim 31, wherein the deposit amount equals a price of the purchase.

37. The system of claim 31, wherein the processor is further configured to deduct the compensation from the deposit amount based on the providing of the compensation.

38. The system of claim 31, wherein the compensation is provided to the user until the deposit amount exhausts.

39. The system of claim 31, wherein the processor is further configured to calculate the compensation based on the notification, wherein the calculation is performed according to predefined criteria.

40. The system of claim 31, wherein the notification includes at least the payment amount and credentials associated with the mobile payment account of the user.

41. The system of claim 31, wherein an online payment using the mobile payment service is secured by two-factor authorization.

42. The system of claim 31, wherein the user makes a payment via the mobile payment service through an application installed on a mobile device associated with the user.

43. The system of claim 31, wherein a payment via the mobile payment service is performed as a direct operator billing.

44. The system of claim 31, wherein the mobile payment service is associated with a bank card, wherein the user specifies whether a payment is charged to the bank card.

45. The system of claim 31, wherein the processor is further configured to, on receiving an audio signal via near sound data transfer or data over voice, display a payment barcode encoding data associated with the mobile payment card on a screen of a mobile device of the user.

46. The system of claim 45, wherein the payment barcode includes one or more of the following: a linear barcode, a two-dimensional barcode, a three-dimensional barcode, and a machine readable code.

47. The system of claim 31, wherein the processor is further configured to, on receiving a signal by near field communication, perform a payment using the mobile payment card, wherein the payment is performed on condition of an approval of the user.

48. The system of claim 31, wherein the processor is further configured to, on receiving an audio signal via near sound data transfer or data over voice, enable an electronic transaction through the mobile payment service.

49. The system of claim 31, wherein the mobile payment service is issued by a mobile operator.

50. The system of claim 31, wherein an issuing entity associated with the mobile payment service acts independently from financial institutions and mobile operators.

51. The system of claim 31, wherein an issuing entity associated with the mobile payment card is a collaborative body including a bank, a mobile operator, and a trusted third party.

52. The system of claim 31, wherein the processor is further configured to receive a Bluetooth Low Energy (BLE) signal, the BLE signal being sensed by the mobile device of the user, the user being authenticated via the BLE signal.

53. The system of claim 31, wherein a creditworthiness rating of the user is calculated by checking credit history of the user.

54. The system of claim 53, wherein calculating the creditworthiness rating of the user includes verification of employment status of the user.

55. The system of claim 31, wherein the mobile payment service is associated with one or more of the following: a credit card, a debit card, a retail card, a charge card, a prepaid card, a gift card, a merchant card, a mobile account card, a mobile currency card, and a stored-value card.

56. The system of claim 31, wherein the mobile device includes one or more of the following: a mobile phone, a personal digital assistant, a laptop, a tablet personal computer, a smart phone, a digital watch, augmented reality glasses, a digital bracelet, a digital ring, a wearable personal digital device, a desktop computer, and an internet-connected TV-set.

57. The system of claim 31, wherein the compensation is issued by one or more of the following: a bank, a credit card company, an insurance company, a credit union, a mobile payment service provider, and a store.

58. The system of claim 31, wherein the compensation is transmitted to the mobile device via a wireless network.

59. The system of claim 31, wherein an online payment using the mobile payment service is secured by two-factor authorization.

60. The system of claim 31, wherein the user makes a payment via the mobile payment service through an application on the mobile device.

61. The system of claim 31, wherein the compensation includes one or more of the following: loyalty credits provided for participation in loyalty programs, a repayment of a percentage of an amount of purchases made with the mobile payment service provider, a refund of bank services, a discount on mobile services, free mobile services, zero monthly fee, a free bank service, a free insurance service, saved payment card charges.

62. The system of claim 61, wherein the free bank service include one or more of the following: early account closure fee, monthly or annual maintenance fee, minimum balance fee, refundable deposit fee, foreign transaction fee, lost debit card fee, bank statement fee, redeemed rewards points fee, retained mail fee, refundable mail fee, help desk fee, wire transfer fee, stop payment fee.

63. The system of claim 61, wherein the free bank service is provided by one or more of the following: a related bank, a bank of the mobile payment service provider.

64. The system of claim 61, wherein the free insurance service is provided by an insurance company of the mobile payment service provider or related insurance company.

65. The system of claim 61, wherein the compensation includes one or more of the following: free repair of the mobile device, free exchange of the mobile device, free receipt of spare parts for the mobile device, free of dongles charges by scanning payment cards information, and free of monthly phone fee.

66. The system of claim 31, wherein the mobile payment card is used with a customized version of the open standard Extensible Messaging and Presence Protocol, wherein a user account is created using a phone number or a name associated with the mobile device of the user, and wherein phone numbers in an address book of the mobile device are compared with a central database of users to automatically add contacts and send mobile payment cards barcode to the contacts of the user to charge the payments.

67. The system of claim 31, wherein the mobile payment card is used with a cross-platform instant messaging subscription service, wherein the user sends one or more mobile payment card barcodes, images, video, and audio media messages to further users, the cross-platform instant messaging subscription service being compatible with Google Android, iPhone IOS, Microsoft Windows Phone and other operation systems, wherein the cross-platform instant messaging subscription service is a free mobile messages application for smartphones with features of: free text and free call, hold-to-talk messaging, broadcast messaging, photo and video sharing, location sharing, contact information exchange, and social networking payment support, wherein the user specifies a validity period for any of the features.

68. The system of claim 31, wherein the processor is further configured to provide tools to capture one or more images, embellish the one or more images with artistic filters and captions, place the one or more images into a personal photo journal for sharing with further users.

69. The system of claim 31, wherein user data and mobile payment cards are protected via an on-demand contact list backup and retrieval to and from the cloud.

70. The system of claim 31, wherein the user specifies a time period during which the mobile payment card is valid.

71. The system of claim 31, wherein the mobile payment card encodes one or more of the following: a picture of a face of the user, one or more fingerprints of the user, and a pin code.

72. The system of claim 31, wherein the mobile payment card is issued after an approval of a mobile payment provider, the mobile payment card being configured to made purchases with a plurality of merchants, wherein the merchants accept the mobile payment card.

73. The system of claim 31, wherein the mobile payment card is used as a prepaid mobile payment card.

74. The system of claim 31, wherein the mobile payment service is associated with one or more of the following: a daily limit for a maximum amount of expenditures, a limit for a minimum balance.

75. The system of claim 31, wherein information of the mobile payment card is encoded in a barcode.

76. The system of claim 31, wherein the mobile payment card is associated with transactional payments based on Unstructured Supplementary Service Data (USSD) or Short Message Service (SMS), direct operator billing, credit card mobile payments, online wallets, QR code payments, contactless near field communication, cloud-based mobile payments, audio signal-based payment, Bluetooth Low Energy (BLE) signal beacon payment, in-application payment, SDK payment, API payment, social networking payment, and direct carrier/bank co-operation.

77. The system of claim 31, wherein the user makes a purchase using a direct mobile billing option during checkout at an online store, wherein a mobile account of the user is directly charged for an amount of the purchase.

78. The system of claim 31, wherein a mobile payment service provider has operator-centric model, bank-centric model, collaboration model or peer-to-peer independent model.

79. The system of claim 31, wherein mobile payments have collaboration model, wherein the collaboration is among banks, mobile operators and a trusted third party.

80. The system of claim 31, wherein a merchant associated with the purchase is charged with a predefined fee deducted from the payment amount.

81. The system of claim 31, wherein a beacon mobile payment sends out a Bluetooth Low Energy (BLE) signal to a device with mobile application to transfer payment data and get electrical receipt.

82. The system of claim 31, wherein mobile payment cards, mobile wallet and mobile payments are provided a software developers kit (SDK) and application programming interface (API).

83. The system of claim 31, wherein an issuer of the mobile payment card commits to pay a merchant immediately when the transaction is authorized.

84. The system of claim 31, wherein the user makes an internet payment using the mobile payment card, wherein the internet payment is secured by a pin.

85. The system of claim 31, wherein the mobile payment card is associated with rewards and benefit packages, the rewards and benefit packages including enhanced product warranties at no cost, free loss and damage coverage on new purchases, insurance protection, rental car insurance protection, common carrier accident protection, and travel medical insurance.

86. The system of claim 31, wherein the user makes a payment using a web page displayed or an additional application downloaded and installed on the mobile device, the payment made on a base of Wireless Application Protocol (WAP).

87. The system of claim 31, wherein a mobile payment service includes a plastic card payment flow, wherein the user enters details of a plastic card associated with the user to make purchases.

88. The system of claim 31, wherein the user authenticates payments using a pin code, the pin code being sent to the mobile device of the user via SMS.

89. The system of claim 31, wherein the processor is further configured to determine a barcode, wherein the barcode is captured by the mobile device, and generate a payment barcode associated with the mobile payment card and the barcode.

90. The system of claim 31, wherein the purchase is associated with a cloud-based payment, wherein the payment amount is covered by a payment provider, the payment amount being recouped from a cloud-linked account associated with the user.

91. The system of claim 31, wherein the mobile payment card application is deployed by a bank, the bank providing acceptance capability at a point of sale associated with merchants.

92. The system of claim 31, wherein a mobile provider provides a front end interface for the user.

93. A non-transitory computer-readable medium comprising instructions, which when executed by one or more processors, perform the following operations:
receive a deposit amount associated with a purchase related to a user, the purchase made via a mobile payment service;
receive payment information associated with the user, the payment information being associated with a mobile payment account of the user in the mobile payment service;
receive a notification about a further purchase of the user via the mobile payment service; and
provide a compensation from the deposit amount, the compensation being proportional to a payment amount associated with the further purchase.
